(19) United States
(12) Patent Application Publication
(10) Pub. No.: US 2024/0153230 A1
(43) Pub. Date: May 9, 2024

(54) GENERALIZED THREE DIMENSIONAL MULTI-OBJECT SEARCH

(71) Applicant: Brown University, Providence, RI (US)

(72) Inventors: Kaiyu ZHENG, Providence, RI (US); Stefanie TELLEX, Providence, RI (US)

(21) Appl. No.: 18/500,768

(22) Filed: Nov. 2, 2023

Related U.S. Application Data
(60) Provisional application No. 63/476,358, filed on Dec. 20, 2022.
(60) Provisional application No. 63/382,263, filed on Nov. 3, 2022.

(51) Int. Cl. G06V 10/25; B25J 9/16; G06T 7/70; G06T 15/06

(52) U.S. Cl. CPC G06V 10/25; B25J 9/1697; G06T 7/70; G06T 15/06; G06V 2201/07

(57) ABSTRACT

A method includes, in an automated machine equipped with one or more camera-based object detectors, receiving human-provided information or information inferred from point cloud observations regarding target locations, maintaining information states regarding the target locations through a probability distribution structured as an octree, initializing the information states based on point cloud observations, updating the information states based on object detection observations or point cloud observations, determining a search region occupancy through constructing an octree-based occupancy grid based on point cloud observations, and using ray-tracing to determine visibility at three dimensional locations within the search region.

### CROSS-REFERENCE TO RELATED APPLICATION(S)

The present application claims priority benefit of U.S. Provisional Application No. 63/382,263 filed Nov. 3, 2022, and U.S. Provisional Application No. 63/476,358 filed Dec. 20, 2022, each of which are incorporated herein by reference in its entirety.

### STATEMENT AS TO FEDERALLY SPONSORED RESEARCH

This invention was made with government support under grant number FA9550-21-1-0214 awarded by the Air Force Office of Scientific Research and grant number W911NF-21-2-0296 awarded by the U.S. Army Research Office. The government has certain rights in the invention.

### BACKGROUND OF THE INVENTION

The present invention relates generally to object search, and more particularly, to a generalized three dimensional (3D) multi-object search.

In general, the ability for robots to search for objects is not only valuable by itself (e.g., for search and rescue), but also as a critical prerequisite for subsequent tasks. One can expect that eventually any robot can acquire this ability off-the-shelf to search for objects in the environment that it operates in, similar to other capabilities such as object detection, SLAM, and motion planning. However, unlike the other aforementioned robotic capabilities, there is no general-purpose object search package available for robotics researchers and practitioners. Sophisticated mobile robot platforms, such as the Kinova MOVO and the Boston Dynamics Spot, do not come equipped with an object search system, despite their otherwise impressive capabilities. What is needed is a system and method for generalized object search.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features a method including, in a robot equipped with one or more camera-based object detectors, receiving an input, the input including point cloud observations of a local region, and localization of a robot camera pose, and outputting a viewpoint to move to as a result of sequential online planning.

In another aspect, the invention features a method including, in an automated machine equipped with one or more camera-based object detectors, receiving human-provided information or information inferred from point cloud observations regarding target locations, maintaining information states regarding the target locations through a probability distribution structured as an octree, initializing the information states based on point cloud observations, updating the information states based on object detection observations or point cloud observations, determining a search region occupancy through constructing an octree-based occupancy grid based on point cloud observations, and using ray-tracing to determine visibility at three dimensional locations within the search region.

In still another aspect, the invention features a system including a robot equipped with one or more camera-based object detectors, and a gRPC framework including a gRPC client and a gRPC server, the gRPC client providing an interface between the robot and the gRPC server, the gRPC server maintaining an occupancy octree, a Partially Observable Markov Decision Process (POMDP) agent and a belief state.

These and other advantages of the invention will be further understood and appreciated by those skilled in the art by reference to the following written specification, claims and appended drawings.

### BRIEF DESCRIPTION OF DRAWINGS

FIG. 1 is a block diagram of an exemplary system.

FIG. 2 is a block diagram of an exemplary GenMOS system.

FIG. 3 illustrates exemplary belief states.

FIG. 4 illustrates exemplary states.

FIG. 5 illustrates exemplary candidate target objects.

FIG. 6 illustrates exemplary local regions.

FIG. 7 illustrates exemplary key frames from local region search trials.

FIG. 8 illustrates an exemplary demonstration of hierarchical planning.

FIG. 9 illustrates an exemplary algorithm.

FIG. 10 is a flow diagram.

FIG. 11 is a flow diagram.

### DETAILED DESCRIPTION OF THE PREFERRED EMBODIMENT(S)

It is to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Successfully finding objects in the real world ultimately depends on searching carefully within 3D local regions, which is subject to limited field of view, occlusion, and unreliable object detectors. In addition, the robot may be tasked to find multiple objects at once, which increases the search space exponentially. Furthermore, to be user-friendly, such a system should allow interpretable understanding of the robot's current state of uncertainty about the target object locations, as well as the robot's search behavior.

Prior work in object search has modeled the problem as a Partially Observable Markov Decision Process (POMDP); it is a principled framework for sequential decision-making under partial observability and perceptual uncertainty, characteristics central to object search. However, due to computational complexity of the problem in 3D, most work constrained the search space or action space of the robot in two dimensions (2D). Other work attempts to learn a policy for 3D object search through end-to-end training of deep neural networks, given RGB images as input. Nevertheless, those approaches have been primarily evaluated in simulation, and it is hard to train a model on a robot and ensure generalization to a different environment.

To address these challenges, the present invention presents GenMOS (Generalized Multi-Object Search), a general-purpose object search system that is robot-independent and environment-agnostic. The system leverages gRPC, a high-performance, cross-platform, and open source remote procedural call (RPC) framework. The server hosts a POMDP model of the search agent, which contains the agent's belief state and POMDP models implemented using pomdppy. The server also maintains an octree representation of the search region's occupancy, used to simulate occlusion enabled observations for belief update. As shown in FIG. 2, the client sends to the server configurations of the POMDP agent, perception data, and planning requests, and executes the action returned by the server. The perception data includes point cloud observations of the local search region, 3D object detection bounding boxes, and localization of the robot camera pose. The server may also actively request information (such as additional observation about the search region's occupancy), which enables the implementation of hierarchical planning.

The present invention enables robots equipped with camera-based object detectors to actively search for and localize multiple target objects simultaneously in 3D regions. Target objects may be occluded partially or completely by obstacles. A robot may begin with no information, human-provided prior information, or information inferred from point cloud observations (if available) regarding the target object locations. Information states regarding target object locations are maintained through the a probability distribution structured as an octree, also known as octree belief, and updated based on object detection observations or point cloud observations.

The present invention dynamically determines search region occupancy through constructing an octree-based occupancy grid based on point cloud observations, and uses ray-tracing to determine visibility at 3D locations within the search region. The system performs sequential decision-making based on Partially Observable Markov Decision Process (POMDP) model for 3D multi-object search to determine viewpoints for the robot to move to and observe at. The system automatically declares an object to be found by signaling. The location of the found object is indicated in the information state at the found signal. The system allows interpretable visualization of the search process and decision-making process through exposing data structures of the information state, the decision-making search tree, and the viewpoint graph. Implementations of the invention enable different robots products to perform search for various objects in various environments under uncertainty and occlusion.

Inside GenMOS, we build on a recent work that models observations as voxels within a frustum-shaped field-of-view (FOV) as part of a POMDP-based approach to 3D multi-object search. Central to that approach is a technique called octree belief that represents belief over object locations in the structure of an octree. It affords exact and efficient sampling and belief update, while allowing incremental construction as the robot searches through the region. However, that work did not address the issue of assigning prior probabilities over the octree structure, which is crucial for practical applications that involve searching in various kinds of environments. The present invention proposes a method to efficiently initialize an octree belief based on prior knowledge about the region such as occupancy. Additionally, we instantiate the action space of that POMDP model by considering a belief-dependent graph of viewpoint positions sampled from the continuous 3D search region, which allows the output space of GenMOS to be the continuous space of possible viewpoints.

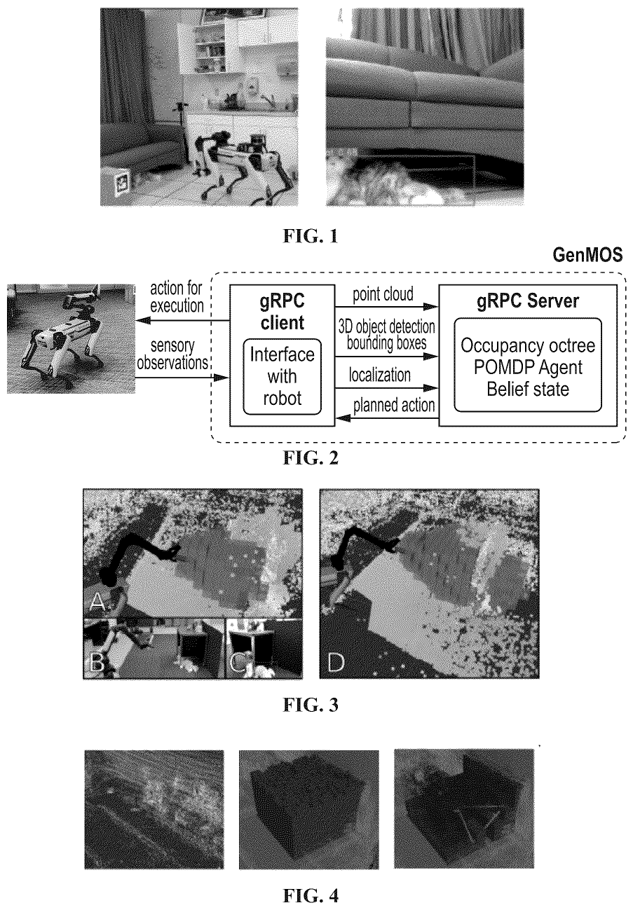

We first evaluate our system in a simulation domain, and then test our system with the Boston Dynamics Spot robot. In the robot evaluation, we task the Spot to search for one or more objects in a region of arranged tables and kitchen region at the resolution of 0.001 m³. Our system enables the robot to find, for example, a cat underneath the couch (see FIG. 1). The robot is also able to look underneath tables, above at shelves, and at the kitchen sink based on the dynamically observed 3D structure of the environment. Finally, we implement a hierarchical planning method to handle larger areas that integrates 3D local search with a POMDP planner for 2D global search, demonstrating this system in a 25 m² lobby area.

POMDP is a principled framework to model a sequential decision making task under uncertainty and partial observability, suitable for object search. Zheng introduced a POMDP-based approach for 3D multi-object search. Below, we provide a brief review for POMDPs and that approach, including the 3D-MOS model and the octree belief representation.

Formally, a POMDP is defined as a tuple (S, A, O, T, O, R, Y′), where S, A, O denote the state and observation spaces, and the functions T(s, a, s′)=Pr(s′|s, a), O(s′, a, o)=Pr(o|s′, a) and R(s, a)∈R denote the transition, observation and reward functions. As the environment state s is partially observable, the POMDP agent maintains a belief state bₜ(s)=Pr(s|hₜ) given current history hₜ=(ao)_{1:t-1}. Upon taking action at and receiving observation oₜ, the agent updates its belief by bₜ₊₁(s′)=n(s′, a, o)ΣₛT(s, a, s′)bₜ(s) where n is the normalizing constant. The objective of online POMDP planning is to find a policy π(bₜ)∈A which maximizes the expectation of future discounted rewards V^{π}(bₜ)=E[Σₖ₌₀^{9∞}γ^{k}(sₜ₊ₖ, π(bₜ₊ₖ))|bₜ with a constant factor_{γ}.

A 3D-MOS is an Object-Oriented POMDP (00-POMDP), which is a POMDP with state and observation spaces factored by objects. 3D-MOS is defined as follows:
State space S. A state s={s₁, . . . , sₙ, sᵣ} consists of n the target object states and a robot state sᵣ. Each sᵢ∈G is the 3D location of the target i where G is the discretized search region, and sᵣ=(q, F)∈Sᵣ, where q=(p, θ) is the 6D camera pose and F is the set of found objects. The robot state is assumed to be observable.
Observation space O. An observation o about the objects, defined as o={(v, d(v)|v∈V)}, is a set of labeled voxels within FOV V where a detection function d(v) labels voxel v to be either an object i∈{1, . . . , n}, FREE or UNKNOWN. FREE indicates the voxel is a free space or an obstacle, and UNKNOWN indicates occlusion caused by target objects or obstacles in the search region.
Action space A. Generally, an action can be MOVE(sᵣ, p) (move to a reachable position p∈P, LOOK (θ) (projects field of view at orientation θ∈SO(3)), or F IND(i, g) (declares object i found at g∈G).
Transition function T. Objects are static. MOVE(sᵣ, p) and LOOK (θ) actions change the robot's camera position and orientation top and θ following domain dynamics. FIND (I,G) adds i to the set of found objects in the robot state only if g is within the FOV determined by sᵣ.
Observation function O. The observation model is defined as Pr(oᵢ|sᵢ, a)=Pr(d(s′ᵢ)|s′, a) where Pr(d(s′ᵢ)=i|s′, a)=α and Pr(d(s′ᵢ)=i|s′, a)=β. The parameters α and β control the reliability of the detector, and are used during octree belief update.
Reward function R. The reward function is sparse. If FIND is taken, yet no new objects are found, the agent receives Rₘᵢₙ (−1000); Otherwise, the agent receives Rₘₐₓ (+1000). If MOVE or LOOK is taken, the agent receives a step cost dependent on the robot state and the action itself.

An octree belief is a belief state b^{t}ᵢ for object i that consists of an octree Ψ(b^{t}ᵢ) and a normalizer. The normalized belief at g^{l} equals to: bⁱₜ(g^{l})=V N ORMₜ (g^{l}), where V ALⁱₜ is the value stored in node at g^{l}∈G^{l} at resolution level l that covers a cubic volume of (2^{l})³ The set of nodes at resolution level k<l that reside in a subtree rooted at g′ is denoted CH^{k} (g^{l}). The value stored in a node is the sum of values stored in its children. The normalizer N ORMₜ=P_{g∈G} V ALⁱₜ(g) equals to the sum of values stored in nodes at the ground resolution level. Querying the probability at any node is achieved by setting a default for V ALⁱₒ(g)=1 for all ground cells not yet present in the tree. Then, any node corresponding to gⁱ has a default value of V ALⁱₒ(g^{l})=P_{Ch}^{l}(g^{l})V alⁱₒ(c)=|CH⁰(g^{l})|.

Updating the octree belief is exact and efficient with a complexity of O(|V|log(|G|)). Sampling is also exact and efficient with a complexity of O(log(|G|).

Here, we describe the problem setting to which GenMOS is applied. A robot is tasked to find one or multiple objects in a 3D region. The robot is assumed to be able to localize itself within the region through its on-board localization module and estimate the pose of its camera. The robot can control the 6-DoF pose (position and orientation) of its camera within a known, continuous reachable space R⊆P×SO(3), where P is the set of reachable positions. The robot can also receive observations streaming through its perception modules, including point cloud and object detection results. The observations are subject to limited field of view, occlusion, noise and errors. To perform object search, the robot should move its camera to different poses (i.e., viewpoints) sequentially to perceive the search region, and declare autonomously a target object to be found based on detection results. The search is evaluated based on the amount of time taken to find objects and the success rate. To be useful for downstream tasks, the robot needs to identify the 3D locations of found objects.

We present GenMOS, a general-purpose system for object search in 3D regions. As a gRPC-based system (see FIG. 2), GenMOS is independent of, thus integrable to any particular robot middleware such as ROS or ROS 2. The server internally maintains a POMDP model of the search task, which is a 3D-MOS with an instantiation of the action space based on a graph of viewpoint positions. The definition and implementation of this model, based on pomdppy, is general and does not depend on any particular environment.

The client sends point cloud observations to the server to update the server's model of the search region. Specifically, the server converts the point cloud into an occupancy octree, where a leaf node in the tree has an associated value of occupancy (0 for free, and 1 for occupied). The occupancy octree is used by the server for both sampling the viewpoint positions graph to avoid collision, as well as for constructing volumetric observations during belief update, where occupied nodes block the FOV and cause occlusion (see FIG. 3).

The server can also take in 3D object detection bounding boxes, which represent the output of a generic object detector or perception pipeline capable of estimating the detected object's 3D location. The bounding box's size plays a role in the octree belief update, as it influences the volumetric observation, where voxels overlapping with the bounding box are labeled by the detected object and leads to an increase in the octree belief at the corresponding locations.

When planning requests are sent from the client, the server performs online planning using an asymptotically optimal, Monte Carlo Tree Search-based online POMDP planning algorithm called POUCT. The server converts the planned camera viewpoint q′∈R to metric coordinates in the frame of the search region. The client is responsible for the execution of moving the robot to that viewpoint. If the server plans a FIND action, the client should send back the detected target objects (if any). The client is also responsible for sending new observations once action execution is complete The actual search region that the robot operates in is most likely not a cubic volume, which is what an octree belief covers by default. Using a bigger octree to cover a larger volume than the search region causes the robot to constantly believe that the target objects may be located outside of the search region, for which the values of the corresponding octree nodes could never be updated. This could negatively impact search behavior.

To address this problem, we modify the way octree belief is initialized. Our algorithm is described in Algorithm 1. The key idea is that the default value of all nodes in the octree belief is first set to 0. Then, through a sample-based procedure, nodes whose corresponding 3D positions lie within the given search region G. have their default values changed to 1. This effectively reduces the sample space of the octree belief to be within the search region G. An initial prior value can be assigned (line 8-9) and the tree can be pruned (line 11-12). The proposed algorithm has complexity of O(N log(|G|)).

In practice, the server determines the search region G* based on the occupancy octree constructed from point cloud observations, and we assign a prior value of 100×((2^{k})³ to occupied nodes in the octree at a given resolution level k. The evaluation of 3D-MOS in Zheng only considered moving the camera in cardinal directions, or over a fixed topological map. To enable planning over the continuous space of viewpoints R, we sample a viewpoint position graph M_{V}=(P_{M},E_{M}) based on the octree belief. At a high level, given an occupancy octree, we first sample set of non-occupied positions with a minimum separation threshold (0.75 m), and associate with each position the belief at that position (possibly at a lower resolution to cover more space). Then, we select top-K nodes ranked by their beliefs and insert edges such that each node has a limited maximum out-degree (5 in our experiments). A MOVE (sᵣ, pᵥ) action then moves the robot to a viewpoint position pᵥ on the graph. We enforce a LOOK(θ) to be taken after a MOVE that changes the camera's orientation to be facing the location of an unfound object sampled from the belief.

In the gRPC framework, remote procedural calls (RPCs) are defined as Protocol Buffer messages. In particular, the key RPCs in GenMOS are as follows:
CreateAgent: Upon receiving the POMDP agent specification from the client, the server prepares for create pending the first UpdateSearchRegion call.
UpdateSearchRegion: The client sends over a point cloud of the local search region, and the server creates or updates the occupancy octree about the search region.
ProcessObservation: The client requests belief update by sending observations such as object detection and robot pose estimation.
CreatePlanner: The client provides hyperparameters of the planner, and the server creates an instance of the POUCT planner in pomdppy accordingly.
PlanAction: The client requests the server to plan an action for an agent. An action is planned only if the last planned action has been executed successfully.
ListenServer: This is a bidirection streaming RPC that establishes a channel of communication of messages or status between the client and the server.

We task a simulated robot (represented as an arrow for its viewpoint) to search for two virtual objects (cubes) with volume 0.002 m³ each in a region of size 10.2 m²×2.4 m². The robot's frustum camera model has a field of view of 61 degrees and minimum range of 0.2 m and maximum range of 1.75 m. For comparison, we tested three different types of priors, groundtruth, uniform, and occupancy-based prior, which uses our proposed algorithm to initialize octree belief based on occupancy. We also tested two different ground resolution levels for the octree belief, 0.001 m³ (octree size 32×32×32) and 0.008 m³ (octree size 16×16×16) representing the granularity of the search.

We evaluate the search performance by four metrics: total path length traversed during search (Length), total time used for POMDP planning (Planning time), total time of search (Total time), and success rate. Note that the total time of search includes time for executing navigation actions; the simulated robot has a translational velocity of 1.0 m/s, and a rotational velocity of 0.87 rad/s.

We ran experiments on a computer with i7-8700 CPU. We perform 10 search trials per method and report the average of each metric in Table I. Results indicate that the system is able to enable effective search, successfully completing majority of the trials. Searching with a resolution level more coarse than the target size may hurt performance. Having an occupancy-based prior improves the result, since objects are not located in mid-air.

We deploy our system to the Boston Dynamics Spot by writing a client for GenMOS that interfaces with the Spot SDK. Spot is a mobile manipulator robot that is robust at navigation while avoiding obstacles. Our Spot robot is equipped with an arm that has a gripper with an RGB-D camera, which has a depth range of around 1.5 m. However, motion planning of the arm does not have collision checking.

Nevertheless, our package is able to output viewpoints that are far enough away from obstacles to enable collision-free search, leveraging the point cloud received from the Spot's on-board cameras. We use Spot's off-the-shelf GraphNav service to map the search region (without the presence of the target objects) and then localize the robot within it.

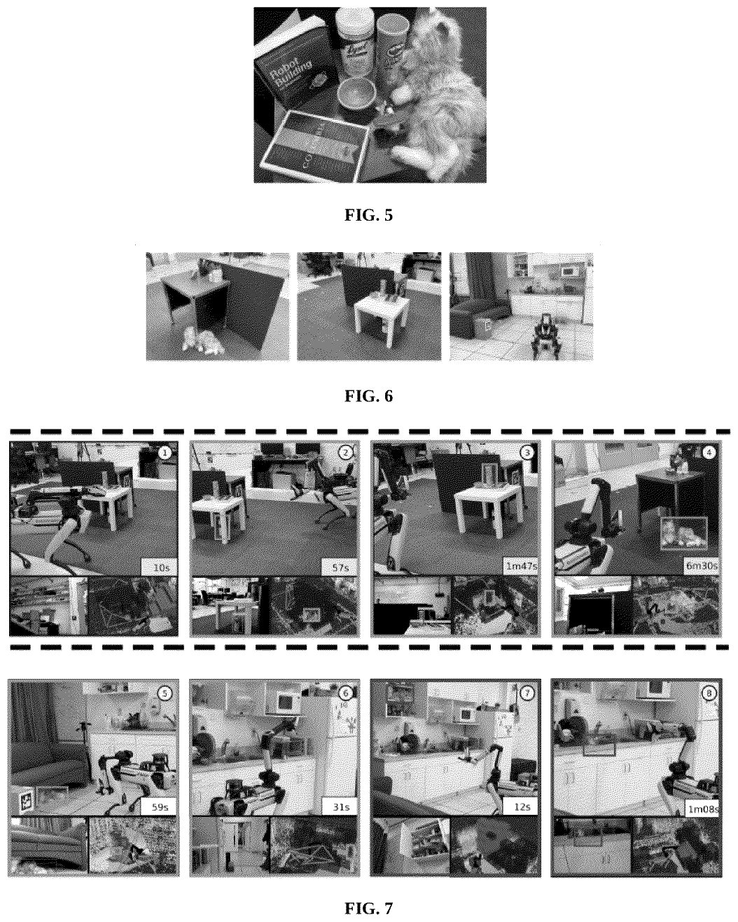

We task the robot to search in 2 different local regions in different rooms of our lab (see FIG. 6). The first region (of size 9 m²×1.5 m) consists of two tables and a separation board which creates occlusion; The target objects can be on the floor, or on or under tables (note that the robot is only given point cloud observations, not semantic knowledge). The second region (of size 7.5 m²×2.2 m) is a kitchen area, where target objects can be on the countertop, on or underneath the couch, on the shelf, or in the sink. In both environments, the resolution of the octree belief is set to 0.001 m³ with a size of 32×32×32. The robot is given at most 10 minutes to search. We collected a dataset of 230 images and trained a YOLOv5 detector with 1.9 million parameters for the target objects of interest (see FIG. 5). We project the 2D bounding box to 3D using the depth image through the gripper camera.

FIG. 7 contains illustrations of several key frames during the search trials in both regions. Video footage of the search together with visualization of the robot's belief state are available in the supplementary video. In the arranged tables region, Our system enables Spot to simultaneously search for four objects (Cat, Pringles, Lyzol, and ToyPlane), and successfully find three objects in 6.5 minutes. In the kitchen region, our system enables Spot to find a Cat placed underneath the couch within one minute. However, we do observe that search success deteriorates due to false negatives from the object detector, as well as conservative viewpoint sampling for obstacle avoidance, which prevents the robot to plan top-down views from above the countertop, for example. Overall, our system enables the robot to search for objects in different environments within a moderate time budget.

We envision the integration of our 3D local search algorithm with a global search algorithm so that a larger search space can be handled. To this end, we implemented a hierarchical planning algorithm that contains a 2D global planner, where the global planner has a stay action (no viewpoint change) which triggers the initialization of a 3D local search agent. In particular, our implementation uses the ListenServer streaming RPC; when the planner decides to search locally, we let the server send a message that triggers the client to send over an UpdateSearchRegion request to initialize the local 3D search agent.

We additionally deployed GenMOS to the Kinova MOVO mobile manipulator, a robot with a mobile base, an extensible torso, and a head that can pan and tilt, and it is equipped with a Kinect V2 RGBD camera. Similar to Spot, we deployed GenMOS to MOVO by integrating the GenMOS gRPC client with the perception, navigation and control stacks of MOVO. We evaluated the resulting object search system in a small living room environment. The robot is able to perform search and successfully finds a toy cat on the floor under 2 minutes. Compared to Spot, however, MOVO is less agile and prone to collision with obstacles while navigating between viewpoints during the search.

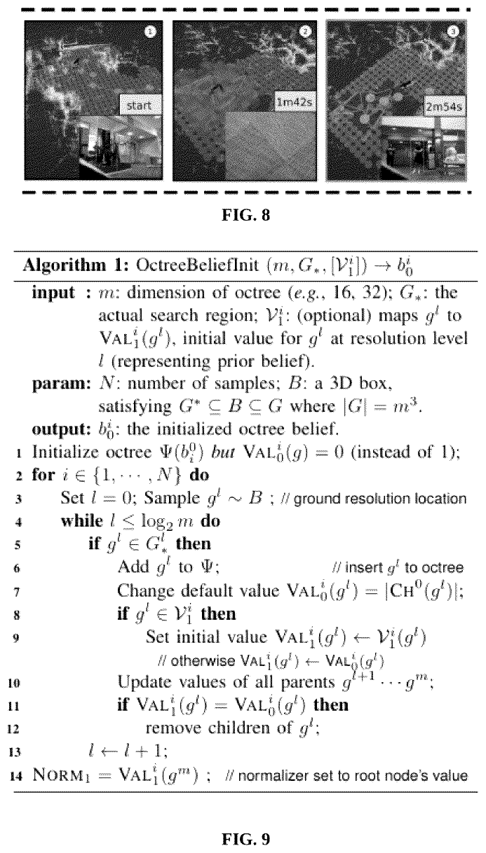

The starting belief of the 3D local agent is initialized based on the 2D global belief, which is in turn updated by projecting the 3D field of view down to 2D. We set the resolution of 2D search to be 0.009 m³, and the resolution of 3D search to be 0.001 m³. We test this system in a lobby area of size 25 m²×1.5 m, where the robot is tasked to find the toy cat on a tall chair (see FIG. 8). The search succeeds within three minutes, searching over roughly 15 m².

In summary, as shown in FIG. 1, our system, GenMOS, enables a Boston Dynamics Spot robot, or any robot, to successfully find a toy cat underneath the couch. The left image shows a third-person view of the scene. The right image shows the RGB image from the gripper camera, with the cat labeled.

An overview of the GenMOS system is shown in FIG. 2.

In FIG. 3, for belief update, GenMOS samples a volumetric observation (a set of labeled voxels within the viewing frustum) that considers occlusion based on the occupancy octree dynamically built from point cloud (A). Not enabling occlusion (D) leads to mistaken invisible locations as free. The robot is looking at a table corner (B) with its view blocked by the table and the board (C).

In FIG. 4, on the Left: Simulation environment where the pose of the robot's viewpoint is represented by the red arrow, and the two target objects are represented by orange and green cubes. Middle: initialized octree belief given uniform prior; Right: initialized octree belief given occupancy-based prior constructed from point cloud. Colors indicate strength of belief, from red (high) to blue (low).

In FIG. 5, candidate target objects in our evaluation are illustrated. From left to right, the object labels are: Columbia Book, Robot Book, Bowl, Lyzol, ToyPlane, Pringles, and Cat.

In FIG. 6, local regions in our evaluation with Spot are shown. Left two: two views of the arranged tables region. A black board separates the two tables to block the view from one side to the other. Right: the kitchen region, with a couch, a countertop, and a shelf.

FIG. 7 illustrates key frames from local region search trials. Each frame consists of three images: a third-person view (top), an image from Spot's gripper camera with object detection (bottom left), and a combined visualization of the octree belief, viewpoint graph, and local point cloud observations. Green boxes indicate successfully finding the marked object. Red boxes indicate failure of finding the object due to false negatives in object detection. The yellow or white box on the right of each frame indicates the amount of time passed since the start of the search. Frames at the top row belong to a single trial in the table region, while frames at the bottom row belong to distinct trials in the kitchen region. The top row (1-4) shows that GenMOS enables Spot to successfully find multiple objects in the table region: Lyzol under the white (2), Pringles on the white table (3), and the Cat on the floor under the wooden table (4). The bottom row shows the GenMOS enables Spot to find a Cat underneath the couch (5), and the Pringles at the countertop corner (6). (7-8) shows a failure mode, where the GenMOS plans a reasonable viewpoint, while the object detector fails to detect the object (Cat) on the shelf or in the sink.

FIG. 8 illustrates demonstration of hierarchical planning where a 2D global search is integrated with 3D local search through the stay action. This system enables the Spot robot to find a Cat in a lobby area within 3 minutes. (1) Initial state; (2) searching in a 3D local region; (3) the robot detects the Cat and the search finishes.

In FIG. 9, exemplary algorithm 1 is shown.

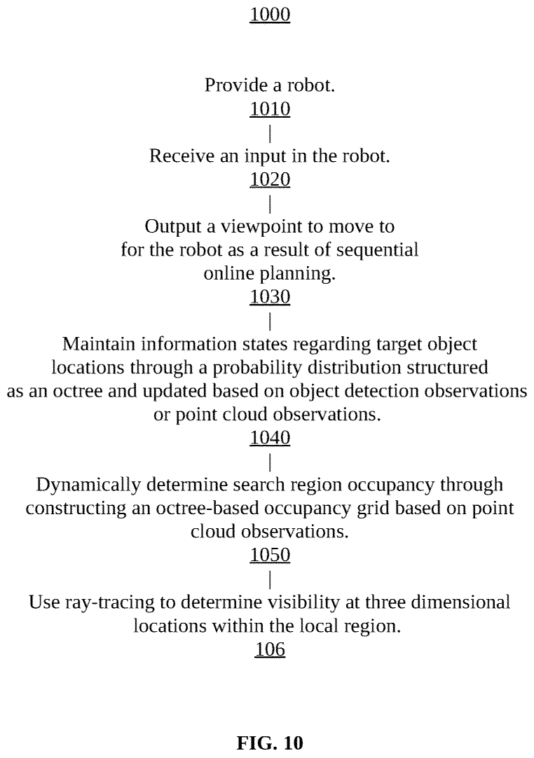

Referring now to FIG. 10, in one embodiment, a process 1000 includes providing (1010) a robot. The robot is equipped with at least one or more camera-based object detectors.

Process 1000 includes receiving (1020) an input in the robot. The input includes point cloud observations of a local region. The input also includes localization of a robot camera pose.

Process 1000 includes outputting (1030) a viewpoint to move to for the robot as a result of sequential online planning.

In an implementation, outputting viewpoints for the robot to move to and observe at is performed by sequential decision-making based on Partially Observable Markov Decision Process (POMDP) model for three dimensional multi-object search. Here, viewpoint candidates are initialized and updated by sampling from the local region based on a current information state and occupancy to form a viewpoint graph.

In embodiments, the received input can include three dimensional (3D) bounding boxes with detected object labels. Here, each of the object labels can include a label.

In embodiments, the received input can include segmented point clouds for detected objects with detected object labels.

In embodiments, the received input can include two dimensional (2D) bounding boxes on an image paired with a corresponding depth image with detected object labels.

In embodiments, the received input can include detected object labels.

Process 1000 may also include maintaining (1040) information states regarding target object locations through a probability distribution structured as an octree and updated based on object detection observations or point cloud observations.

Process 1000 may additionally include dynamically determining search region occupancy (1050) through constructing an octree-based occupancy grid based on point cloud observations and using (1060) ray-tracing to determine visibility at three dimensional locations within the local region.

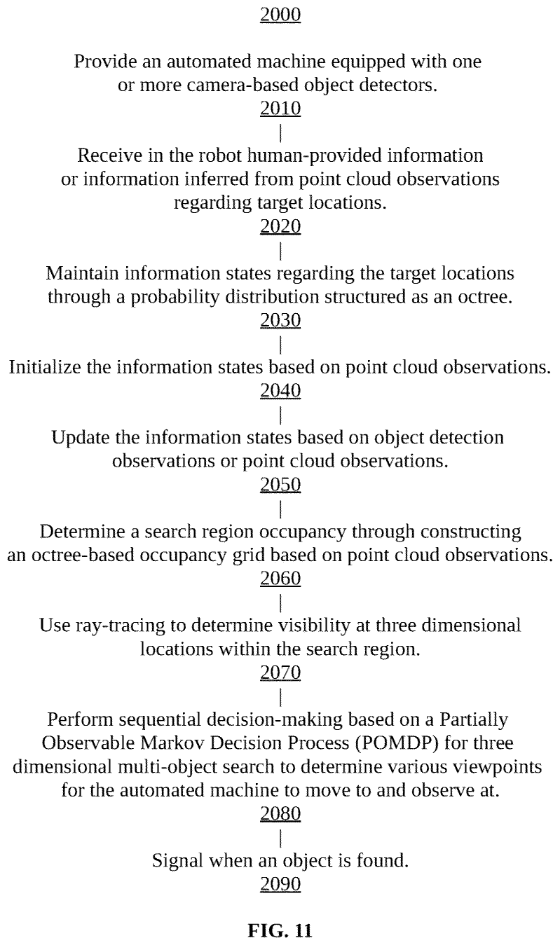

As shown in FIG. 11, in another embodiment, a process 2000 includes providing (2010) an automated machine equipped with one or more camera-based object detectors.

Process 2000 includes receiving (2020) in the robot human-provided information or information inferred from point cloud observations regarding target locations.

Process 2000 includes, in the robot, maintaining (2030) information states regarding the target locations through a probability distribution structured as an octree.

Process 2000 includes, in the robot, initializing (2040) the information states based on point cloud observations.

Process 2000 includes, in the robot, updating (2050) the information states based on object detection observations or point cloud observations.

Process 2000 includes, in the robot, determining (2060) a search region occupancy through constructing an octree-based occupancy grid based on point cloud observations.

Process 2000 includes, in the robot, using (2070) ray-tracing to determine visibility at three dimensional locations within the search region.

Process 2000 may include, in the robot, performing (2080) sequential decision-making based on a Partially Observable Markov Decision Process (POMDP) for three dimensional multi-object search to determine various viewpoints for the automated machine to move to and observe at.

Process 2000 may also include, in the robot, signaling (2090) when an object is found. Here, a location of the found object is indicated in the information state at the time of the found signal.

In the foregoing description, it will be readily appreciated by those skilled in the art that modifications may be made to the invention without departing from the concepts disclosed herein. Such modifications are to be considered as included in the following claims, unless the claims by their language expressly state otherwise.

What is claimed is:

1. A method comprising:
in a robot equipped with one or more camera-based object detectors, receiving an input, the input comprising point cloud observations of a local region, and localization of a robot camera pose; and
outputting a viewpoint to move to as a result of sequential online planning.

2. The method of claim 1 wherein the input further comprises three dimensional (3D) bounding boxes with detected object labels.

3. The method of claim 2 wherein each of the object labels comprises a label.

4. The method of claim 1 wherein the input further comprises segmented point clouds for detected objects with detected object labels.

5. The method of claim 1 wherein the input further comprises two dimensional (2D) bounding boxes on an image paired with a corresponding depth image with detected object labels.

6. The method of claim 1 wherein the input further comprises detected object labels.

7. The method of claim 1 further comprising maintaining information states regarding target object locations through a probability distribution structured as an octree and updated based on object detection observations or point cloud observations.

8. The method of claim 7 further comprising:
dynamically determining search region occupancy through constructing an octree-based occupancy grid based on point cloud observations; and
using ray-tracing to determine visibility at three dimensional locations within the local region.

9. The method of claim 1 wherein determining viewpoints for the robot to move to and observe at is performed by sequential decision-making based on Partially Observable Markov Decision Process (POMDP) model for three dimensional multi-object search.

10. The method of claim 9 wherein viewpoint candidates are initialized and updated by sampling from the local region based on a current information state and occupancy to form a viewpoint graph.

11. A method comprising:
in an automated machine equipped with one or more camera-based object detectors, receiving human-provided information or information inferred from point cloud observations regarding target locations;
maintaining information states regarding the target locations through a probability distribution structured as an octree;
initializing the information states based on point cloud observations;
updating the information states based on object detection observations or point cloud observations;
determining a search region occupancy through constructing an octree-based occupancy grid based on point cloud observations; and
using ray-tracing to determine visibility at three dimensional locations within the search region.

12. The method of claim 11 further comprising performing sequential decision-making based on a Partially Observable Markov Decision Process (POMDP) for three dimensional multi-object search to determine various viewpoints for the automated machine to move to and observe at.

13. The method of claim 12 further comprising signaling when an object is found, wherein a location of the found object is indicated in the information state at the time of the found signal.

14. A system comprising:
a robot equipped with one or more camera-based object detectors; and
a gRPC framework comprising a gRPC client and a gRPC server,
the gRPC client providing an interface between the robot and the gRPC server,
the gRPC server maintaining an occupancy octree, a Partially Observable Markov Decision Process (POMDP) agent and a belief state.

15. The system of claim 14 wherein the belief state represents belief over object locations in the structure of the occupancy octree.

16. The system of claim 15 wherein the occupancy octree represents a search region's occupancy.
